(19) United States
(12) Patent Application Publication
(10) Pub. No.: US 2006/0086666 A1
(43) Pub. Date: Apr. 27, 2006

(54) Device and method for separating blood into leukocyte depleted blood components

(76) Inventors: Giorgio Mari, MIRANDOLA (IT); Paolo Verri, Mirandola (IT)

Correspondence Address: JACOBSON HOLMAN PLLC, 400 SEVENTH STREET N.W., SUITE 600, WASHINGTON, DC, 20004, US

(21) Appl. No.: 10/527,451

(22) PCT Filed: Sep. 19, 2003
(86) PCT No.: PCT/EP03/10454

§ 371 Date: Mar. 11, 2005

(30) Foreign Application Priority Data
Sep. 20, 2002 (IT) TO2002A000820

(51) Int. Cl. B01D 61/00

(52) U.S. Cl. 210/645; 210/651; 210/96.2; 210/130; 210/143; 210/321.6; 604/5.01; 604/6.09

(57) ABSTRACT

A device for separating blood into blood components comprising:—a collecting container (2) for receiving blood (WB),—a first satellite container (4) connected, in fluid flow communication, to said collecting container (2) through a leukocyte filter (22) for receiving from said collecting container (2) a leukocyte depleted first blood component (PRP),—a second satellite container (6) connected, in fluid flow communication, with said collecting container (2) through said filter (22) for receiving from said collecting container a second leukocyte depleted blood component (PRC), and flow control means (36, 38, 42) for allowing fluid flow from said collecting container selectively into said first (4) or second (6) satellite container through said leukocyte filter (22), whereby whole blood (WB) can be separated into a first (PRP) and second (PRC) leukocyte depleted blood component with a single leukocyte filter (22). Preferably the second satellite container (6) is further connected to said collecting container (2) through conduit means (28b, 34, 16a) by-passing said filter (22), and the valve means are further adapted for allowing the transfer of an additive from said second satellite container (6) into said collecting container (2) only through said conduit means (28b, 34, 16a) bypassing said filter (22).

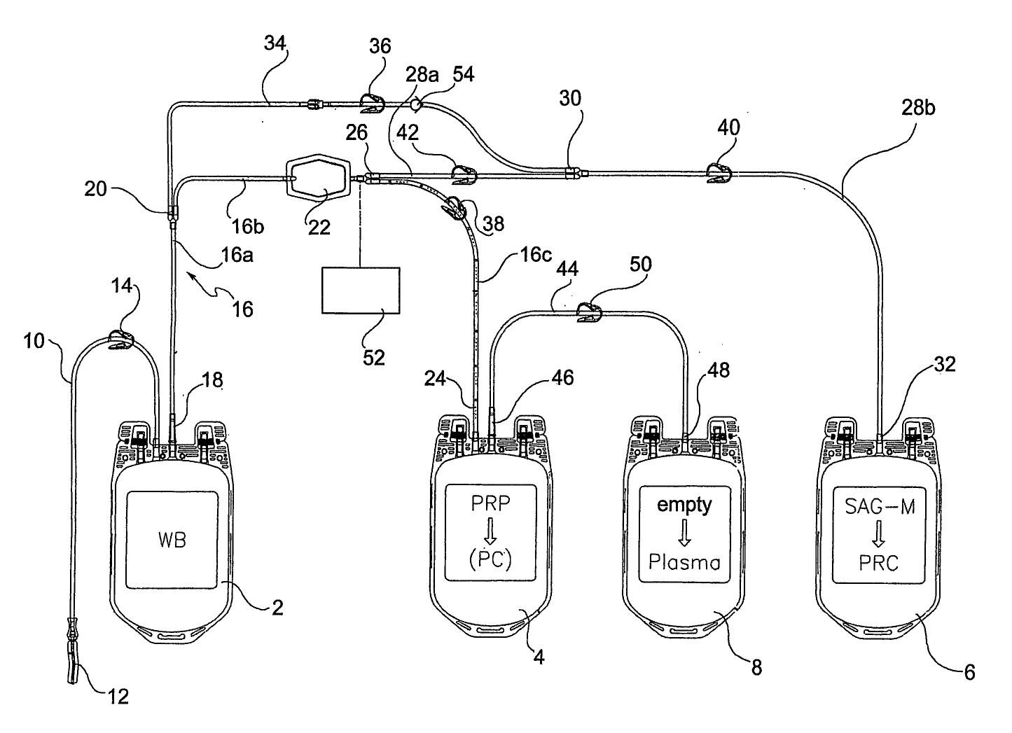

The present invention relates to a device and method for separating blood into leukocyte depleted blood components.

More particularly, the invention concerns a blood bag system used to separate blood components from whole blood and to remove leukocytes from the generated components.

U.S. Pat. No. 4,596,657 describes a device of the above-mentioned type comprising a primary bag for collecting blood, e.g. from a donor, which is connected by means of a flexible conduit to a first satellite bag and through a second flexible conduit to a second satellite bag containing an additive solution; a leukocyte filter is arranged in the second flexible conduit which connects the primary bag to the second satellite bag.

The donor's whole blood collected in the primary bag is first centrifuged to separate the whole blood into a mixed layer of blood plasma and thrombocytes (platelet rich plasma or PRP) and an erythrocyte layer (packed red cells or PRC). The PRP layer is then fed into the first satellite bag and then the additive solution is fed from the second satellite bag into the primary bag. The PRC suspended in the additive solution are then fed from the primary bag, through the second conduit containing the leukocyte filter into the second satellite bag. The known device thus allows to obtain a leukocyte depleted PRC.

EP-A-0 879 608 describes a blood bag device which allows whole blood filtration and which also allows to obtain leukocyte depleted PRC. The described device comprises a collecting bag which is connected to a primary bag through a tubing containing a leukocyte filter and also through a by-pass line circumventing the filter. The donor's whole blood, collected in the collecting bag is first conveyed via the by-pass tubing into the primary container, wherein it is separated by centrifuging into a PRC layer and a PRP layer; the said PRP layer is then conveyed from the primary container into a first satellite container and subsequently, the PRC layer suspended in an additive agent is conveyed from the primary container via the tubing including the leukocyte filter into the collecting bag.

However, the removal of leukocytes from the other two blood components, namely platelet concentrate (PC) and plasma (PL) is also highly desirable.

In order to meet such a need, EP-A-0 556 303 discloses a blood bag system comprising a collecting bag and two satellite bags wherein each satellite bag is connected to the collecting bag through respective separate flexible conduits, each including a respective leukocyte filter. Whole blood is collected in the collecting bag and is centrifuged for separation into its component; then, the filtration of the individual blood component takes place in order to obtain leukocyte depleted PRP and PRC. The leukocyte depleted PRP may then be separated into PL and PC with the use of a third satellite bag.

While the solution of EP-A-0 556 303 is quite simple, such a solution is not cost-efficient nor space-efficient due to the use of a second leukocyte filter; particularly, difficulties may be encountered to fit into the centrifuge bucket four bags and two filters.

An object of the present invention is to provide a blood bag device allowing to separate whole blood into leukocyte depleted PRC, PL and PC which is economical and relatively compact, i.e. with a reduced bulk with respect to known prior art devices.

A further object of the invention is to provide a device which allows the above-mentioned separation with the use of a single leukocyte filter.

In addition, the invention has the objective of providing a method allowing whole blood to be separated into leukocyte depleted blood components with the use of a single leukocyte filter.

These and other objects of the invention are achieved by means of a device comprising:

a collecting container for receiving blood,

a first satellite container connected, in fluid flow communication, with said collecting container through a leukocyte filter, for receiving from said collecting container a leukocyte depleted first blood component and

a second satellite container connected, in fluid flow communication with said collecting container, for receiving from said collecting container a second leukocyte depleted blood component,

characterised in that said second satellite container is connected to said collecting container through said leukocyte filter, flow control means being provided for allowing fluid flow from said collecting container selectively to said first or second satellite container through said leukocyte filter.

In a preferred embodiment of the invention, said second satellite container is further connected to said collecting container through conduit means by-passing said filter and said flow control means are adapted to allow fluid flow from said second satellite container into the collecting container only through the conduit means by-passing the filter.

According to a preferred embodiment of the invention, which allows to carry out a method of separation of whole blood into leukocyte depleted PRC, PL and PC, which will be described in the following, the second satellite container initially contains a blood additive for storing erythrocytes such as a SAG-M solution and the device further includes a third satellite container which is connected, in fluid flow communication, to the first satellite container for receiving from said first satellite container a leukocyte depleted third blood component.

According to a further preferred embodiment of the invention, the blood bag device of the invention comprises sensor means for detecting a parameter representative of the presence of said second hemocomponent in the filtrate from the leukocyte filter and the flow control means are adapted to switch fluid flow communication from said collecting container to said first satellite container to fluid flow communication from the collecting container to the second satellite container when the sensor means detect the presence of said second hemocomponent.

Further characterising features of the device and of the method for using the device for providing leukocyte depleted blood components are defined in the appended claims.

The invention will be further described in the following with reference to the annexed drawing which provides, by way of non limiting example, a schematic representation of the device of the invention in a specific embodiment.

As shown in the drawing, the device for separating blood into blood components comprises a collecting container 2, a first satellite container 4, a second satellite container 6 and preferably a third satellite container 8 which, as known in the art, consist of flexible and pliable plastics bags.

Collecting bag 2, which is adapted to receive whole blood WB, may have an associated flexible tubing 10 with a hose clamp 14 and a terminal needle 12 adapted to be inserted into the donor or other whole blood supply source.

Collecting bag 2 is connected to first satellite bag 4 through a flexible tubing 16, including tubing section 16a extending from an outlet port 18 of collecting bag 2 to a 3-way connector 20, tubing section 16b extending from 3-way connector 20 to an inlet port of a leukocyte filter 22 and a tubing section 16c extending from an outlet port of leukocyte filter 22 to an inlet port 24 of first satellite bag 4.

Leukocyte filter 22, which is adapted for the depletion of the leukocyte content of blood components fed from collecting bag 2 to satellite bags 4 and 6, as it will be seen in more detail in the following, may consist of any leukocyte filter device known in the art such as described e.g. in EP-A-0 313 348, U.S. Pat. No. 4,963,260 and U.S. Pat. No. 5,580,465.

Said filter device 22 may include in addition to porous elements, specifically adapted for leukocyte removal, additional filter elements for the removal of gels and micro-aggregates.

Downstream of leukocyte filter 22, tubing section 16c has a branch off provided by means of a 3-way connector 26, whereby the exit from the leukocyte filter is further connected to satellite bag 6 through tubing sections 28a, extending from tubing connector 26 to a 3-way tubing connector 30 and tubing section 28b extending from tubing connector 30 to an inlet port 32 of satellite bag 6.

Collecting bag 2 is further connected to satellite bag 6 through a by-pass tubing section 34, by-passing leukocyte filter 22 and extending from 3-way tubing connector 20 to 3-way tubing connector 30.

Valve means, typically consisting of hose clamps, identified with reference numerals 36, 38 and optionally 40 are provided, respectively on tubing sections 34, 16c and 28b; optionally, valve means consisting of a hose clamp 42 may also be provided on tubing section 28a.

The said valve means are adapted to cut off flow in the corresponding tubing sections and optionally can be automatically operated.

Preferably, in substitution or in addition to valve means 36, a one-way valve 54 is provided in tubing section 34 allowing fluid flow only from satellite bag 6 to collecting bag 2, to prevent unfiltered blood to flow into satellite bag 6.

The first satellite bag 4 is connected to third satellite bag 8 by means of a tubing 44 extending from an outlet port 46 of satellite bag 4 to an inlet port 48 of third satellite bag 8; valve means 50 can be provided to cut off flow in tubing 44.

The method for separating blood into leukocyte depleted blood components, with the use of the device of the invention according to the preferred embodiment hereinbefore described is as follows.

Whole blood WB is initially collected into collecting bag 2, which may initially contain an anti-coagulation agent. The whole blood in collecting bag 2 is then separated, in a known manner, e.g. by centrifuging into platelet rich plasma (PRP) and packed red cells (PRC).

The valve means, as above described, are then operated to allow fluid flow from collecting bag 2 to satellite bag 4 through leukocyte filter 22, while excluding fluid flow through by-pass tubing 34 and through tubings 28a and 28b; PRP is then transferred, e.g. by gravity, from collecting bag 2 into satellite bag 4 passing through leukocyte filter 22 to provide leukocyte depleted PRP into satellite bag 4 which is initially empty.

The valve means can then be selectively operated to allow fluid flow from satellite bag 6 into collecting bag 2 only through by-pass tubing 34, thereby to transfer an additive solution (e.g. SAG-M) from satellite bag 6 into collecting bag 2 containing the PRC.

The valve means are then operated to allow fluid flow communication from collecting bag 2 into satellite bag 6 through leukocyte filter 22, while excluding fluid flow through by-pass tubing 34, thereby to transfer PRC suspended in the additive solution from collecting bag 2 into satellite bag 6 under filtration conditions which provides for leukocyte depletion.

At the beginning of this second filtration step, filter 22 is still loaded with the PRP from the first filtration step. In order to allow recovery of the PRP filter hold-up into satellite bag 4, at the beginning of the second filtration step, preferably, valve means 38 are open to allow fluid flow into satellite bag 4, while valve means 42 and/or 40 are closed so as to prevent fluid flow into satellite bag 6; valve means 38 are then switched into the closed position and simultaneously, valve means 42 and 40 are switched into the open position as soon as the presence of red cells (PRC) is detected in the filtrate from filter 22.

To this end, sensor means (52) may optionally be provided for detecting a parameter which is indicative of the presence of red cells in the filtrate.

Sensor means suitable to detect the presence of red cells are known in the art and may consist, by way of example, of a colorimetric sensor device.

PRP collected in satellite bag 4 and already depleted from leukocytes can be centrifuged again, in a high spin, to separate plasma (PL) from platelet concentrate (PC) and the PL can be transferred into a third satellite bag 8 through tubing 44. Thus, the described method of use is able to generate three hemocomponents (PRC, PL and PC) all depleted of leukocytes, with the use of a single filter.

The invention has been herein described with reference to the simplest embodiment, wherein the flow control means are manually operated valves, such as hose clamps.

In a further and preferred embodiment of the invention, the (preferably disposable) blood bag equipment—as described—can be used in association with a (non-disposable) bag separator equipment, such as those conventionally used to squeeze the bags after centrifugation and separate the hemocomponents.

Such equipment shall include sensor means for detecting fluid flow or the presence of fluid at selected locations of the bags and/or conduit means and electro-mechanical valve means which are remotely controlled by the sensor means to provide fluid flow connection between the bags, according to the hereinbefore described process steps.

Preferably, the sensor means include a sensor which can detect red cells in the filtrate from leukocyte filter 22 and the control means are adapted to switch fluid flow communication in order to cut flow through tubing 16c and allow flow through tubings 28a and 28b when the presence of red cells is detected.

1. A device for separating blood into blood components comprising:
a collecting container (2) for receiving blood (WB),
a first satellite container (4) connected, in fluid flow communication, to said collecting container (2) through a leukocyte filter (22) for receiving from said collecting container (2) a leukocyte depleted first blood component (PRP),
a second satellite container (6) connected, in fluid flow communication, with said collecting container (2) for receiving from said collecting container a second leukocyte depleted blood component (PRC),
characterised in that said second satellite container (6) is connected to said collecting container (2) through said leukocyte filter (22), flow control means (36, 38, 42) being provided for allowing fluid flow from said collecting container selectively into said first (4) or second (6) satellite container through said leukocyte filter (22), whereby whole blood (WB) can be separated into a first (PRP) and second (PRC) leukocyte depleted blood component with a single leukocyte filter (22).

2. A device according to claim 1, characterised in that said second satellite container (6) is further connected to said collecting container (2) through conduit means (28b, 34, 16a) by-passing said filter (22), the said flow control means (36, 38, 42) being further adapted for allowing fluid flow from said second satellite container (6) into said collecting container (2) only through said conduit means (28b, 34, 16a) by-passing said filter (22).

3. A device according to claim 2, characterised in that said second satellite container (6) includes a blood additive and wherein said flow control means (36, 38, 42) are adapted to selectively:
feeding a first blood component (PRP) from said collecting container (2) into said first satellite container (4) through said leukocyte filter (22) to provide a leukocyte depleted blood component into said first satellite container (4);
feeding said blood additive from said second satellite container (6) into said collecting container (2) only through said conduit means (28, 34, 16a) by-passing said filter (22) and
feeding a second blood component (PRC) from said collecting container (2) into said second satellite container (6) only through said leukocyte filter (22) to provide into said second satellite container (6) a second leukocyte depleted blood component (PRC).

4. A device according to claim 1, characterised in that it comprises:
first conduit means (16a, 16b, 16c) connecting said collecting container (2) to said first satellite container (4) through said leukocyte filter (22),
second conduit means (28a, 28b) branching off (26) from said first conduit means (16c) downstream of said leukocyte filter (22), thereby to connect said collecting container (2) to said second satellite container (6), and
by-pass conduit means (34) branching off (20) from said first conduit means (16a), upstream of said leukocyte filter (22) and connected to said second conduit means (28b).

5. A device according to claim 1, characterised in that said flow control means (36, 38, 42) comprise sensor means for detecting fluid flow or presence of fluid at selected positions of the device and electro-mechanical valve means (36, 38, 42) operated and controlled by said sensor means.

6. A device according to claim 1, characterised in that said flow control means comprise sensor means (52) for detecting a parameter representative of the presence of said second blood component (PRC) in the filtrate from said leukocyte filter (22) and automatically operated valve means (38, 42) adapted to switch fluid flow communication from said collecting container (2) to said first satellite container (4) to fluid flow communication from said collecting container (2) to said second satellite container (6) when the sensor means (52) detect the presence of said second blood component (PRC).

7. A device according to claim 1, characterised in that said flow control means (36, 38, 42) comprise manually operated valves.

8. A device according to claim 4, characterised in that a one-way valve (54 or 36) is provided in by-pass conduit means (34) allowing fluid flow only from second satellite container (6) to collecting container (2).

9. A device according to claim 4, characterised in that said flow control means comprise valve means (40, 42) in said second conduit means (28a, 28b).

10. A device according to claim 1, characterised in that said flow control means (36, 38, 40, 42, 52) are associated with a separator device adapted to cause fluid flow from the collecting container (2) to the satellite containers (4, 6).

11. A device according to claim 1, characterised in that it further comprises a third satellite container (8) connected in fluid flow communication with said first satellite container (4) for receiving from said first satellite container (4) a third blood component (PL).

12. A method for separating blood into leukocyte depleted blood components comprising the steps of:
providing a blood separator device comprising a collecting container (2) for receiving blood, a first satellite container (4) connected, in fluid flow communication, to said collecting container (2) through a leukocyte filter (22) and a second satellite container (6) connected, in fluid flow communication, to said collecting container through said leukocyte filter (22),
separating blood collected in said collecting container (2) into a first (PRP) and second (PRC) blood component,
feeding said first blood component (PRP) from said collecting container (2) into said first satellite container (4) through said leukocyte filter to provide a leukocyte depleted first blood component into said first satellite container, while leaving the second blood component (PRC) within said collecting container (2),
adding into said collecting container (2) an additive solution for the second blood component (PRC),
feeding said second blood component (PRC) suspended in said additive into said second satellite container (6) passing through said leukocyte filter (22).

13. A method according to claim 12, wherein said additive solution is fed from said second satellite container (6) into said collecting container (2) through by-pass conduit means (34), by-passing said leukocyte filter (22).

14. A method according to claim 12, comprising the steps of:
detecting the presence of said second blood component (PRC) in the filtrate from said leukocyte filter (22) and
switching fluid flow communication from said collecting container (2) to said first satellite container (4) to fluid flow communication from said collecting container (2) to said second satellite container (6) when the presence of said second blood component is detected in the filtrate, thereby to allow recovery into said first satellite container (4) of the filter hold-up of the first blood component (PRP).

15. A method according to claim 12, further comprising separating the second leukocyte depleted blood component (PRP) in said first satellite container (4) into a third (PL) and fourth (PC) blood component and feeding said third blood component (PL) from said first satellite container (4) into a third satellite container (8).

16. Method according to claim 12, carried out with the use of a device having:
a collecting container (2) for receiving blood (WB),
a first satellite container (4) connected, in fluid flow communication, to said collecting container (2) through a leukocyte filter (22) for receiving from said collecting container (2) a leukocyte depleted first blood component (PRP),
a second satellite container (6) connected, in fluid flow communication, with said collecting container (2) for receiving from said collecting container a second leukocyte depleted blood component (PRC),
characterised in that said second satellite container (6) is connected to said collecting container (2) through said leukocyte filter (22), flow control means (36, 38, 42) being provided for allowing fluid flow from said collecting container selectively into said first (4) or second (6) satellite container through said leukocyte filter (22), whereby whole blood (WB) can be separated into a first (PRP) and second (PRC) leukocyte depleted blood component with a single leukocyte filter (22).

17. Method according to claim 13, carried out with the use of a device having:
a collecting container (2) for receiving blood (WB),
a first satellite container (4) connected, in fluid flow communication, to said collecting container (2) through a leukocyte filter (22) for receiving from said collecting container (2) a leukocyte depleted first blood component (PRP),
a second satellite container (6) connected, in fluid flow communication, with said collecting container (2) for receiving from said collecting container a second leukocyte depleted blood component (PRC),
characterised in that said second satellite container (6) is connected to said collecting container (2) through said leukocyte filter (22), flow control means (36, 38, 42) being provided for allowing fluid flow from said collecting container selectively into said first (4) or second (6) satellite container through said leukocyte filter (22), whereby whole blood (WB) can be separated into a first (PRP) and second (PRC) leukocyte depleted blood component with a single leukocyte filter (22).

18. Method according to claim 14, carried out with the use of a device having:
a collecting container (2) for receiving blood (WB),
a first satellite container (4) connected, in fluid flow communication, to said collecting container (2) through a leukocyte filter (22) for receiving from said collecting container (2) a leukocyte depleted first blood component (PRP),
a second satellite container (6) connected, in fluid flow communication, with said collecting container (2) for receiving from said collecting container a second leukocyte depleted blood component (PRC),
characterised in that said second satellite container (6) is connected to said collecting container (2) through said leukocyte filter (22), flow control means (36, 38, 42) being provided for allowing fluid flow from said collecting container selectively into said first (4) or second (6) satellite container through said leukocyte filter (22), whereby whole blood (WB) can be separated into a first (PRP) and second (PRC) leukocyte depleted blood component with a single leukocyte filter (22).

19. Method according to claim 15, carried out with the use of a device having:
a collecting container (2) for receiving blood (WB),
a first satellite container (4) connected, in fluid flow communication, to said collecting container (2) through a leukocyte filter (22) for receiving from said collecting container (2) a leukocyte depleted first blood component (PRP),
a second satellite container (6) connected, in fluid flow communication, with said collecting container (2) for receiving from said collecting container a second leukocyte depleted blood component (PRC),
characterised in that said second satellite container (6) is connected to said collecting container (2) through said leukocyte filter (22), flow control means (36, 38, 42) being provided for allowing fluid flow from said collecting container selectively into said first (4) or second (6) satellite container through said leukocyte filter (22), whereby whole blood (WB) can be separated into a first (PRP) and second (PRC) leukocyte depleted blood component with a single leukocyte filter (22).
